(19) United States
(12) Patent Application Publication
(10) Pub. No.: US 2013/0051893 A1
(43) Pub. Date: Feb. 28, 2013

(54) CIRCULAR MARKING DEVICE

(71) Applicant: BORIS PURIZHANSKY, Orlando, FL (US)

(72) Inventor: BORIS PURIZHANSKY, Orlando, FL (US)

(21) Appl. No.: 13/214,631

(22) Filed: Aug. 22, 2011

(51) Int. Cl. H01B 13/34; B43K 8/00

(52) U.S. Cl. 401/11

(57) ABSTRACT

A circular marking device includes a reservoir for containing a marking fluid, a circular chamber having a hollow center portion in communication with an interior of the reservoir, and a nib positioned along the inside of the circular chamber for depositing the marking fluid onto a circular shaped object in a 360 degree orientation.

### BACKGROUND

### Field of the Invention

The present invention relates generally to marking instruments, and more particularly to a device capable of marking circular instruments such as insulated wires.

Electricians and other such workers are required by the United States Electrical Code to permanently identify the termination points of any conductor wire (i.e., the wire that carries electrical current, also referred to as a “hot” wire) having a white or natural gray insulation. The code requires that any wiring which is exposed (i.e., not located inside a conduit or breaker box) be re-identified by “painting or other effective means.”

As such, it is common practice for electricians to mark the “hot” wire with electrical tape or other such material, however, this practice does not appear to fully comply with the Code requirements and is impractical for situations where large amounts of wire must be marked. Alternatively, electricians may also attempt to utilize a pen or conventional marker for this task, however, owing to the circular shape of the wire this task is often extremely labor and time intensive.

There have been devices for marking electrical wires including U.S. patent application Ser. No. 6,582,142 to Keller. The Keller Patent describes a canister containing permanent ink and a tip having a V-shaped notch for marking a portion of an insulated wire. The Keller patent has a disadvantage of requiring a user to make several passes around large wires in order to mark a 360° area as required by the Code. To this end, as the size of the wire increases, the disadvantage of the Keller device increases exponentially.

The present invention, directed to a circular marking device differs from the foregoing prior art in a number of aspects. The manner by which will become more apparent in the description which follows, particularly when read in conjunction with the accompanying drawings.

### SUMMARY OF THE INVENTION

It is an object of the invention to provide a circular marking device for allowing a user to mark the entirety of a circular device with a single pass.

Accordingly one embodiment of a circular marking device can include a retainer for containing a marking fluid and a circular chamber for positioning a nib capable of imparting a 360 degree mark onto a circular object having a known dimension.

Another embodiment can include a retainer chamber in communication with a flexible hollow member configured to create a circular central chamber having a dimension which can be adjusted by a user.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a top view of a circular marking device in accordance with one embodiment of the invention.

FIG. 2 is a perspective view of a circular marking device in accordance with one embodiment of the invention.

FIG. 3 is another perspective view of a circular marking device in accordance with one embodiment of the invention.

FIG. 4 is a side view of a circular marking device in accordance with an alternate embodiment of the invention.

FIG. 5 is a top view of a circular marking device in accordance with the alternate embodiment of the invention.

FIG. 6 is a perspective view of the circular marking device in operation according to the alternate embodiment.

FIG. 7 is another perspective view of the circular marking device in operation according to the alternate embodiment.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

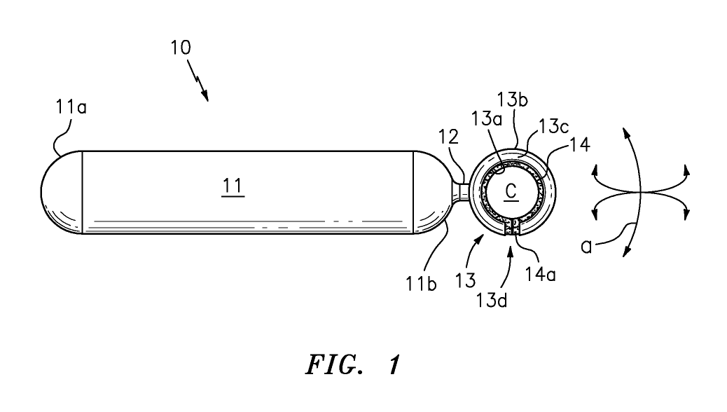

For purposes of this description, the terms “upper,” “bottom,” “right,” “left,” “front,” “vertical,” “horizontal,” and derivatives thereof shall relate to the invention as oriented in FIG. 1.

FIG. 1 illustrates one embodiment of a circular marking device 10 that is useful for understanding the inventive concepts disclosed herein. As shown, the device 10 can include a reservoir 11, having a flexible neck 12, a circular chamber 13 and a nib 14.

The reservoir 11 acts to store a permanent marking fluid such as permanent marker ink, paint or other such material. The reservoir 11 can be constructed substantially identical to a conventional marker having a capped bottom end 11a and a second end 11b that is configured to allow the marking fluid to make contact with the nib 14.

Although not illustrated, the marking fluid can be deposited directly into the reservoir at a time of construction or via a sealable opening. Alternatively, the marking fluid can be inserted via a conventional refillable cartridge configured to deposit the fluid into the circular chamber 13c in a conventional manner. Additionally, the outside of the reservoir 11 can further include a rubber grip/handle (not illustrated) for providing the user additional safety against electrical shock when working with electrical wiring and the like.

As shown, a hollow neck 12 can be interposed between the open end of the reservoir 11b and the circular chamber 13 for allowing the contents of the reservoir 11 to flow into the circular chamber 13, and to be subsequently expelled by the nib 14. In one preferred embodiment, the neck 12 can be constructed from a single piece of flexible plastic or other such material capable of allowing the circular chamber and nib to move in accordance with applied pressure (see arrow a). As will be described below, such a feature can allow a user to easily and comfortably mark circular objects in a 360° orientation.

The chamber 13 can act to position a nib 14 in a circular orientation for providing a 360° mark to a circular object, such as a wire, for example. In one embodiment, the chamber 13 can include a generally “C” shaped member having an inside wall 13a, an outside wall 13b and a hollow interior portion 13c. An opening 13d (defined from the endpoints of the inside and outside walls 13a and 13b, respectively) can be preferably positioned along the bottom portion of the chamber for allowing a wire, or other circular shaped object to be placed within the center of the chamber C.

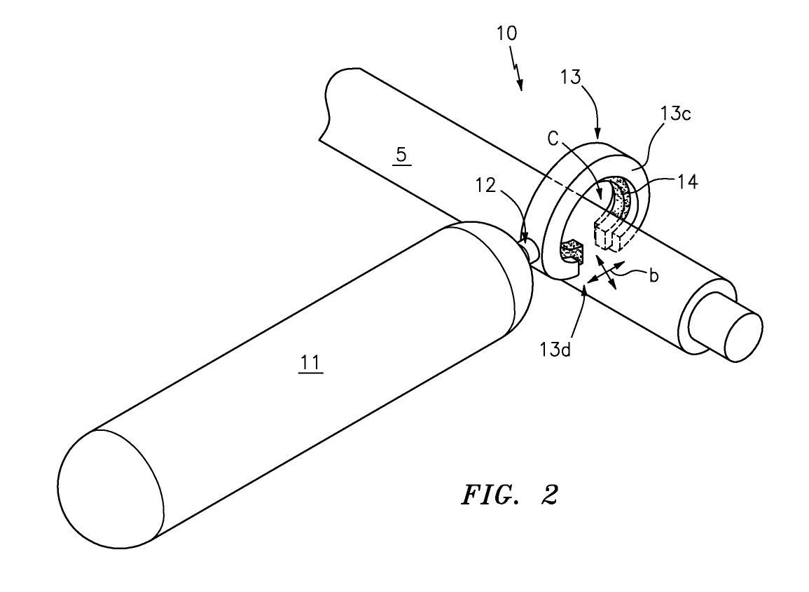

As illustrated in FIG. 2, the circular chamber 13 can be constructed from flexible plastic or other similar material configured to bend and flex when pressure is applied thereto. Such a feature can allow the opening 13d to bend/expand (see arrow b) in order to allow a wire 5 to be inserted into the center chamber C, before returning to its original shape.

The nib 14 can act to apply the marking material contained in the reservoir 11 and the interior of the chamber 13c to a wire or other circular object in a conventional manner. To this end, the nib 14 can be placed along the entirety of the inside wall 13a and along each side of the opening 13d, thus providing a complete 360° coverage area to a wire 5 positioned within the center of the chamber C. In one preferred embodiment, the nib 14 can include oversized endpoints 14a for providing coverage to a wire along the opening 13d, and can be constructed from an elongated strand of felt, foam or other conventional marker tip materials in accordance with known construction practices.

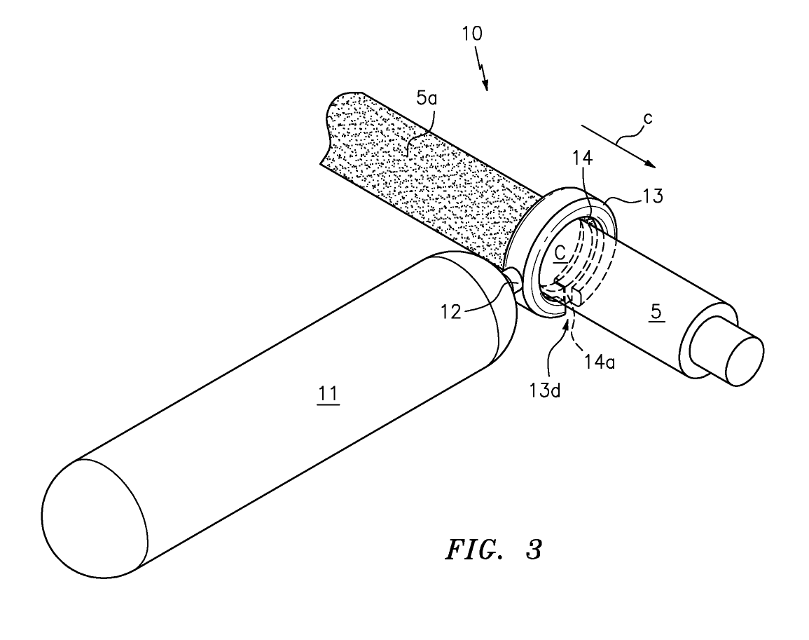

Owing to the fact that electricians typically work with the same size (gauge) wires on a daily basis, the dimension of the chamber center C can be constructed to fit a particular size wire. For example, a circular marking device 10 according to one embodiment can be constructed specific for 3 gauge wires, and can therefore include an inside diameter C that is 0.23 inches. Likewise, another circular marking device can include an inside diameter C that is 0.29 inches for working with 1 gauge wires. In either instance, and as illustrated in FIG. 3, the nib 14 can make contact with an inserted wire 5 in a 360° manner.

As shown in FIG. 3, once a wire is positioned within the center area C, the device 10 can move in a linear direction (see arrow c) to provide a 360° mark (illustrated as 5a) to a wire or other circular object 5.

In another embodiment, the device 10 can further include a cap (not illustrated) configured to cover the chamber 13 in order to prevent the marking fluid from evaporating into the environment. As described herein, the cap can include virtually any size and material capable of lessening the airflow to the nib. As caps of this type and the methodology for constructing the same are well and truly known, no further description will be provided.

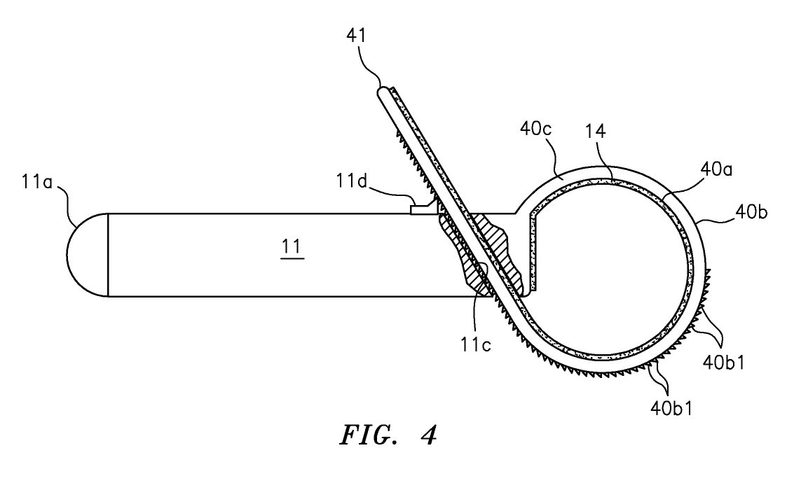

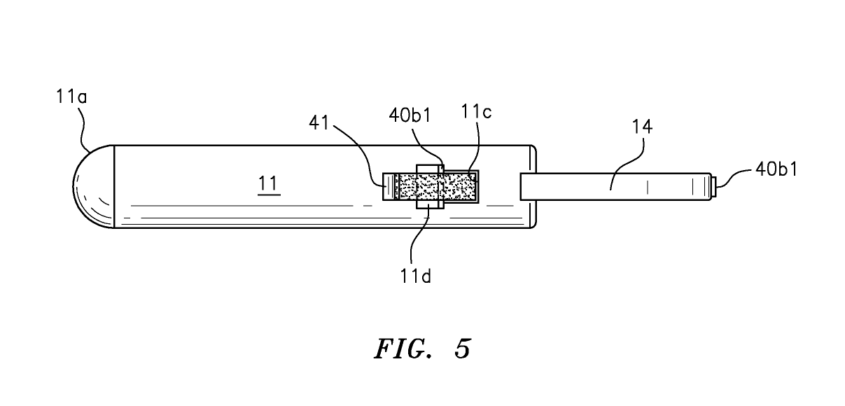

FIGS. 4 and 5 illustrate an alternate embodiment of a circular marking device 10 that is further configured to mark circular objects of varying sizes in a 360° manner. As shown, the reservoir 11 can further include a hollow channel 11c extending from the bottom of the reservoir to the top of the reservoir adjacent to the adjustable chamber 40. Additionally, the top of the retainer can include an adjustable retention clip 11d configured to interact with one or more of the plurality of protrusions 40b1 positioned along the outside of the adjustable chamber 40. Retention clips act to temporarily lock two objects together thus preventing expansion or contraction of the adjustable chamber. As retention clips are extremely well known in the art, no further description will be provided.

The adjustable chamber 40 can act to position the nib 14 in a circular manner for providing a 360° mark to objects of varying dimensions. In one embodiment, the adjustable chamber 40 can include an elongated flexible member having an inside wall 40a, an outside wall 40b and a hollow interior portion 40c. As shown, the outside wall can further include a plurality of protrusions 40b1 configured to interact with the retention clip 11d described above.

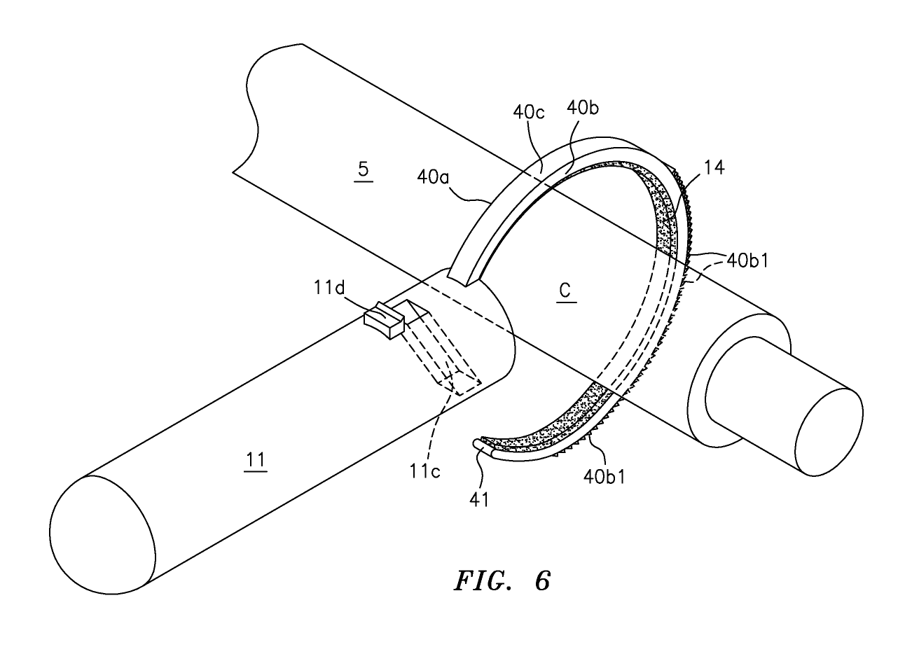

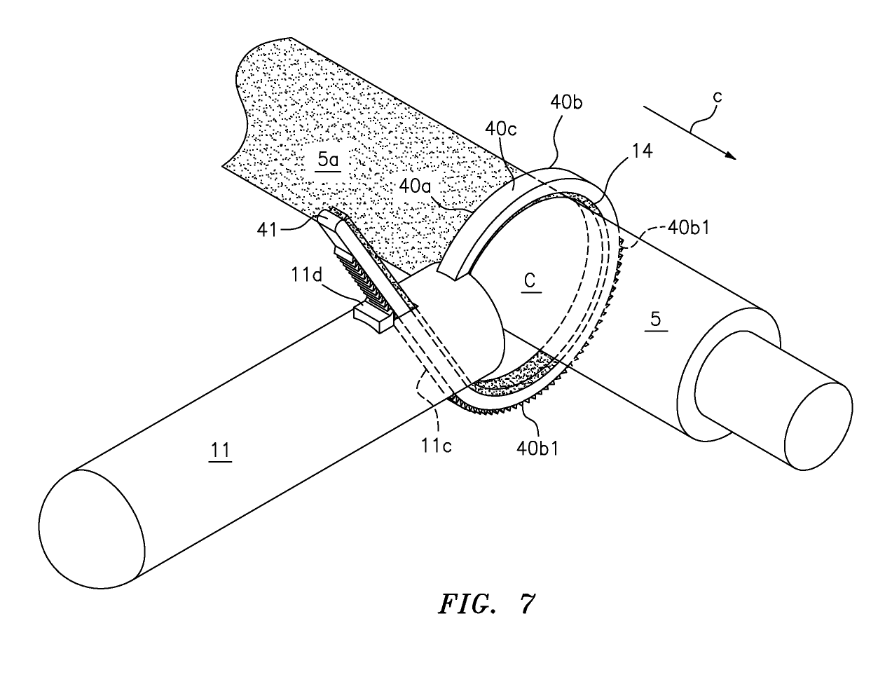

FIGS. 6 and 7 illustrate one embodiment of the device in operation. As shown, the chamber 40 can be positioned around a wire 5 and the endpoint 41 can be inserted through the channel 11c of the retainer. Upon entering the channel 11c, the endpoint can be pulled until the size of the chamber center C is reduced to match the outside diameter of the circular object 5, at which time the retention clip 11d can mate with one or more of the protrusions 40b1. When in this configuration, the nib 14 will be in contact with the object 5 in a 360° manner, and the device can be moved in a linear direction (see arrow c) to provide a 360° mark (illustrated as 5a) to a wire or other circular object.

Although described above for use with electrical wiring, other embodiments are also contemplated. For example, the inventive concepts disclosed herein can be utilized to paint or provide lubrication to cables and wires of all sizes by enlarging the reservoir and/or chamber 13 or 40.

As described herein, one or more elements of the circular marking device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements such as the reservoir 11, neck 12 circular chamber 13 and/or 40 may be formed together as one continuous element, either through manufacturing processes, such as welding, casting, or molding, or through the use of a singular piece of material milled or machined with the aforementioned components forming identifiable sections thereof. Accordingly, in one preferred embodiment, each of the above described elements of the circular marking device 10 can be constructed from injection molded plastic having the features and functionality described above.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A circular marking device comprising:
a reservoir configured to contain a marking fluid;
a circular chamber having a first end, a second end, an inside surface, and a hollow center portion extending from the first end of the circular chamber to the second end of the circular chamber,
wherein said hollow center portion is in communication with an interior of the reservoir; and
a nib positioned secured to the inside surface, the first end and the second end of the circular chamber, said nib being in communication with the hollow center and configured to expel the marking fluid onto a circular shaped object in a 360 degree orientation.

2. The circular marking device of claim 1, further comprising
a flexible neck interposed between the reservoir and the circular chamber, said neck being configured to allow the circular chamber to move in multiple directions when an outside pressure is applied thereon.

3. The circular marking device of claim 1, wherein said marking fluid includes at least one of an ink, paint, and a permanent marker.

4. The circular marking device of claim 1, wherein the reservoir is further configured to receive a refillable ink cartridge.

4. The circular marking device of claim 1, wherein said circular chamber is flexible and configured to bend when a pressure is applied thereon.

5. The circular marking device of claim 4, wherein the first and second ends of the circular chamber define a gap through which a circular object can be inserted.

6. The circular marking device of claim 5, wherein a portion of said nib located at the gap includes a size sufficient to span the gap.

7. The circular marking device of claim 1, wherein the inside surface of the circular chamber includes a dimension approximating a known electrical wire size.

8. The circular marking device of claim 1, further comprising:
a rubberized grip surrounding an outside portion of the reservoir, said grip being configured to protect a user against an electrical shock.

9. A circular marking device comprising:
a reservoir configured to contain a marking fluid, said reservoir including a hollow channel and a retention means;
an hollow flexible member in communication with an interior of the reservoir, said flexible member having a first end, a second end, an inside surface and an outside portion;
a nib positioned secured to the inside surface, the first end and the second end of the flexible member, said nib being in communication with the hollow portion of the flexible member and configured to expel the marking fluid onto a circular shaped object in a 360 degree orientation;
wherein the first end of the flexible member is affixed to a first end of the reservoir, and the second end of the flexible member is configured to be removably inserted into the hollow channel of the reservoir, thus forming a circular chamber, and
said outside portion of the flexible member includes a plurality of protrusions configured to lock with the retention means.

10. the circular marking device of claim 9, wherein a dimension of said circular chamber is configured to be adjustable by a user.

11. The circular marking device of claim 9, wherein said marking fluid includes at least one of an ink, paint, and a permanent marker.

12. The circular marking device of claim 9, wherein the reservoir is further configured to receive a refillable ink cartridge.

13. A circular marking device comprising:
means for containing a marking fluid;
means for positioning a marking device in a circular orientation; and
means for marking a circular shaped object in a 360 degree orientation.
